(19) United States
(12) Patent Application Publication
(10) Pub. No.: US 2014/0208417 A1
(43) Pub. Date: Jul. 24, 2014

(54) SYSTEMS AND METHODS FOR CONTINUOUS BIOMETRIC AUTHENTICATION AND PRESENCE DETECTION OF USER OF AN INFORMATION HANDLING SYSTEM

(71) Applicant: DELL PRODUCTS L.P., Round Rock, TX (US)

(72) Inventor: Charles D. Robison, Round Rock, TX (US)

(73) Assignee: DELL PRODUCTS L.P., Round Rock, TX (US)

(21) Appl. No.: 13/748,004

(22) Filed: Jan. 23, 2013

(51) Int. Cl. G06F 21/32

(52) U.S. Cl. CPC G06F 21/32
USPC 726/19

(57) ABSTRACT

In accordance with embodiments of the present disclosure, an information handling system may include a user interface and a processor communicatively coupled to the user interface. The user interface may comprise a touch sensor configured to detect biometric fingerprint data of a human interacting within a user-interactive area of the user interface. The processor may be configured to receive biometric fingerprint data from the user interface inputted via the user interface during the human's natural interaction with the user interface. The processor may be further configured to determine if the biometric fingerprint data is that of an authorized user of the information handling system. The processor may also be configured to restrict access to the information handling system in response to determining that the biometric fingerprint data is not that of an authorized user of the information handling system.

### TECHNICAL FIELD

The present disclosure relates in general to information handling systems, and more particularly to continuous biometric authentication of presence detection of a user of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Security of information handling systems and the data accessible to them (e.g., locally stored and/or available to an information handling system via a network) is seen as extremely important to users and administrators of information handling systems. In an ideal case, access to an information handling system would require both user authentication (e.g., entry and verification of a user name, password, biometric identifier of the user, etc.) and user presence at the information handling system (e.g., receipt of information relevant to user presence and verification of such information). Typically, many information handling systems are not capable of detecting user presence, and thus as a substitute employ a timeout that “locks” or prevents access to an information handling system if the information handling system has not received input for a specified duration of time. Other approaches employ include facial recognition, context awareness, or geofencing for presence detection, but such approaches may not truly authenticate user presence in that they may be compromised with relative ease.

### SUMMARY

In accordance with the teachings of the present disclosure, the disadvantages and problems associated with user authentication and presence detection for an information handling system have been reduced or eliminated.

In accordance with embodiments of the present disclosure, an information handling system may include a user interface and a processor communicatively coupled to the user interface. The user interface may comprise a touch sensor configured to detect biometric fingerprint data of a human interacting within a user-interactive area of the user interface. The processor may be configured to receive biometric fingerprint data from the user interface inputted via the user interface during the human's natural interaction with the user interface. The processor may be further configured to determine if the biometric fingerprint data is that of an authorized user of the information handling system. The processor may also be configured to restrict access to the information handling system in response to determining that the biometric fingerprint data is not that of an authorized user of the information handling system.

In accordance with these and other embodiments of the present disclosure, a method may include receiving biometric fingerprint data from a user interface comprising a touch sensor configured to detect biometric fingerprint data of a human interacting within a user-interactive area of the user interface, the biometric fingerprint data inputted via the user interface during the human's natural interaction with the user interface. The method may also include determining if the biometric fingerprint data is that of an authorized user of an information handling system comprising the user interface. The method may further include restricting access to the information handling system in response to determining that the biometric fingerprint data is not that of an authorized user of the information handling system.

In accordance with these and other embodiments of the present disclosure, an article of manufacture may include a computer readable medium and computer-executable instructions carried on the computer readable medium. The instructions may be readable by a processor, the instructions, when read and executed, for causing the processor to: (i) receive biometric fingerprint data from a user interface comprising a touch sensor configured to detect biometric fingerprint data of a human interacting within a user-interactive area of the user interface, the biometric fingerprint data inputted via the user interface during the human's natural interaction with the user interface; (ii) determine if the biometric fingerprint data is that of an authorized user of an information handling system comprising the user interface; and (iii) restrict access to the information handling system in response to determining that the biometric fingerprint data is not that of an authorized user of the information handling system.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates a system that may be used in a touch device incorporated into the user interface of the information handling system depicted in FIG. 1; and

FIG. 3 illustrates a state diagram chart depicting an example method for continuous biometric authentication and presence detection of a user of an information handling system, in accordance with certain embodiments of the present disclosure.

### DETAILED DESCRIPTION

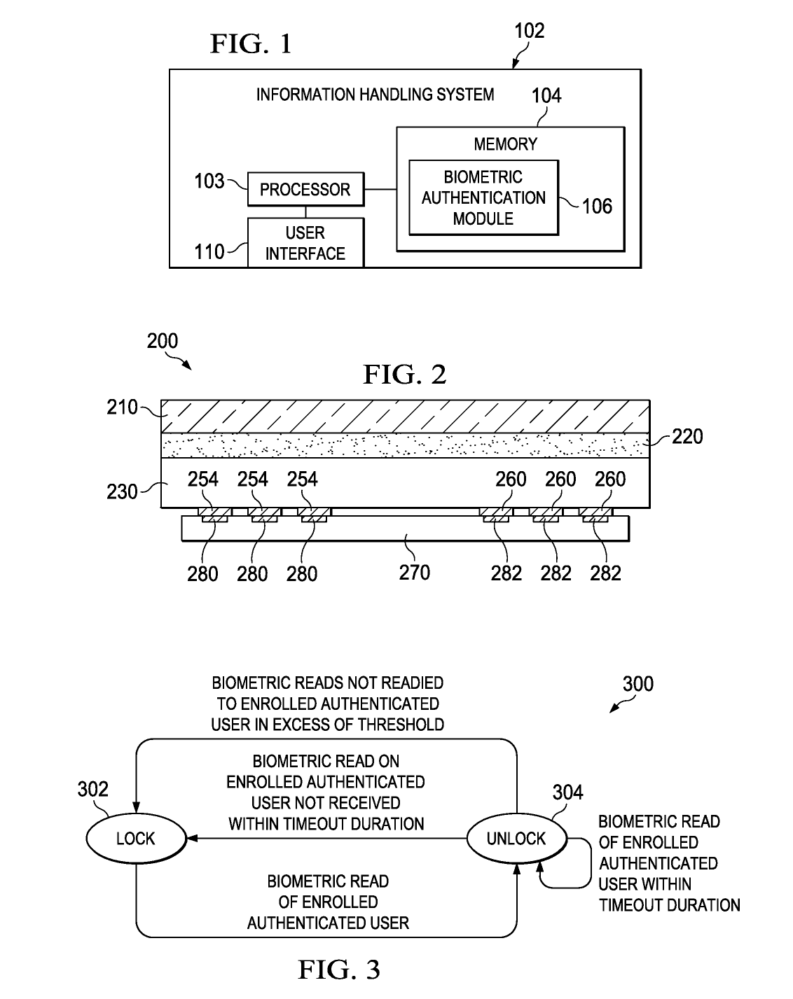

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, busses, memories, I/O devices and/or interfaces, storage resources, network interfaces, motherboards, and/or any other components and/or elements of an information handling system.

FIG. 1 illustrates a block diagram of an example information handling system 102. In some embodiments, information handling system 102 may be a mobile device sized and shaped to be readily transported and carried on a person of a user of information handling system 102 (e.g., a smart phone, a tablet computing device, a handheld computing device, a personal digital assistant, a notebook computer, etc.). As depicted in FIG. 1, information handling system 102 may include a processor 103, a memory 104 communicatively coupled to processor 103, and a user interface 110 coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off. As shown in FIG. 1, memory 104 may have stored thereon a biometric authentication module 106.

Biometric authentication module 106 may include any system, device, or apparatus configured to facilitate user authentication and user presence detection with respect to information handling system 102, as is described in greater detail elsewhere in this disclosure. In some embodiments, biometric authentication module 106 may be implemented as a program of instructions that may be read by and executed on processor 103 to carry out the functionality of one-time biometric authentication module 106. In some embodiments, biometric authentication module 106 may be configured to perform method 300, described below.

User interface 110 may comprise any instrumentality or aggregation of instrumentalities by which a user may interact with information handling system 102. For example, user interface 110 may permit a user to input data and/or instructions into information handling system 102, and/or otherwise manipulate information handling system 102 and its associated components. User interface 110 may also permit information handling system 102 to communicate data to a user, e.g., by way of a display device. In some embodiments, user interface 110 may comprise a touch-screen display. In these and other embodiments, user interface 110 may comprise a biometric fingerprint reader co-terminous with substantially the entire user-interactive area of the touch-screen and capable of reading a user's fingerprint during the user's natural interaction with information handling system 102. As used in the specification and the claims, the term “natural interaction” means the user's interaction with the user interface in order to control a function of the information handling system 102 other than the input of a fingerprint to a biometric fingerprint reader present in the user interface. As used in the specification and the claims, the term “user-interactive area” means the portion of a user interface in which a user interacts with tactile touch during such user's natural interaction with information handling system 102.

In these and other embodiments, user interface 110 may comprise a biometric fingerprint reader co-terminous with substantially the entire user-interactive area of the touch-screen and capable of reading a user's fingerprint during the user's natural interaction with information handling system 102. As used in the specification and the claims, the term “natural interaction” means the user's interaction with the user interface in order to control a function of the information handling system 102 other than the input of a fingerprint to a biometric fingerprint reader present in the user interface. As used in the specification and the claims, the term “user-interactive area” means the portion of a user interface in which a user interacts with tactile touch during such user's natural interaction with information handling system 102.

In addition to processor 103, memory 104, and user interface 110, information handling system 102 may include one or more other information handling resources. An information handling resource may include any component system, device or apparatus of an information handling system, including without limitation, a processor (e.g., processor 103), bus, memory (e.g., memory 104), I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits

FIG. 2 illustrates a system 200 that may be used in a touch-screen device incorporated into user interface 110 of the information handling system 102 depicted in FIG. 1. System 200 may include a touch sensor 230. Coupled to touch sensor 230 may be connection pads 254 and 260. A cover 210 may be coupled to touch sensor 230 via an adhesive 220. A circuit 270 may be electrically coupled to connection pads 254 and 260 via connection pads 280 and 282, respectively. In some embodiments, touch sensor 230 may be configured to detect touches (e.g., capacitively, the touches performed by one or more fingers or a stylus) on cover 210 and produce signals indicative of the detection. Connection pads 260 may be electrically coupled to aspects of touch sensor 230 (such as electrodes) that are aligned in one axis (e.g., the x-axis) and connection pads 254 may be electrically coupled to aspects of touch sensor 230 (such as electrodes) that are aligned in a different axis (e.g., the y-axis). Connection pads 254 and 260 may provide signals to circuit 270.

In some embodiments, cover 210 may include material that allows for detection of touches on cover 210. For example, cover 210 may be made of a resilient material suitable for repeated touching such as, e.g., glass, polycarbonate, or poly(methyl methacrylate) (PMMA). Cover 210 may be clear, opaque, or may have one or more levels of suitable opacities.

In some embodiments, adhesive 220 may be formed of Optically Clear Adhesives (OCA). Adhesives that have levels of opacities other than optically clear may be used to implement adhesive 220. Adhesive 220 may be composed of suitable material (or a combination of materials) that effectively attach touch sensor 230 to cover 210 and circuit 270.

In some embodiments, touch sensor 230 may include one or more electrodes that are configured to detect touches on the surface of cover 210. Touch sensor 230 may be a single-sided touch sensor or a double-sided touch sensor, such as a double-sided FLM (fine line metal) touch sensor. For example, touch sensor 230 may be configured such that electrodes aligned in one axis (e.g., the y-axis) may be present on one surface of touch sensor 230 and electrodes aligned in a different axis (e.g., the x-axis) may be present on another surface of touch sensor 230. As another example, touch sensor 230 may be configured such that electrodes aligned in one axis (e.g., the y-axis) may be present on the same surface of touch sensor 230 (e.g., the surface that faces cover 210) as electrodes aligned in a different axis (e.g., the x-axis).

An electrode of touch sensor 210 (whether a drive electrode or a sense electrode) may be an area of conductive material forming a shape, such as for example a disc, square, rectangle, other suitable shape, or suitable combination of these. One or more cuts in one or more layers of conductive material may (at least in part) create the shape of an electrode, and the area of the shape may (at least in part) be bounded by those cuts. As an example and not by way of limitation, an electrode may be made of fine lines of metal or other conductive material (such as for example copper, silver, or a copper- or silver-based material) and the fine lines of conductive material may occupy substantially less than 200% of the area of its shape in a hatched, mesh, or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns.

Touch sensor 230 may implement a capacitive form of touch sensing. In a mutual-capacitance implementation, touch sensor 230 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other through the dielectric material separating them. A pulsed or alternating voltage applied to the drive electrode may induce a charge on the sense electrode, and the amount of charge induced may be susceptible to external influence (such as a touch or the proximity of an object). When an object touches or comes within proximity of the capacitive node, a change in capacitance may occur at the capacitive node and a controller may measure the change in capacitance. By measuring changes in capacitance throughout the array, the controller may determine the position of the touch or proximity within the touch-sensitive area(s) of touch sensor 230.

In a self-capacitance implementation, touch sensor 230 may include an array of electrodes of a single type that may each form a capacitive node. When an object touches or comes within proximity of the capacitive node, a change in self-capacitance may occur at the capacitive node and a controller may measure the change in capacitance, for example, as a change in the amount of charge needed to raise the voltage at the capacitive node by a pre-determined amount. As with a mutual-capacitance implementation, by measuring changes in capacitance throughout the array, the controller may determine the position of the touch or proximity within the touch-sensitive area(s) of touch sensor 230. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 230 may have drive electrodes disposed in a pattern on one side of a substrate and sense electrodes disposed in a pattern on another side of the substrate or both the drive electrodes and the sense electrodes may be in patterns on the same side of touch sensor 230 (e.g., when touch sensor 230 is implemented as a single-sided touch sensor). An intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes.

In some embodiments, circuit 270 may be implemented using a flexible printed circuit. Any suitable set of materials and/or components may be used to implement circuit 270 that allows for the provision of signals to touch sensor 230 (via connection pads 254 and 260) and the reception of signals from touch sensor 230 (via connection pads 254 and 260). Circuit 270 may be coupled to other components, subsystems, or systems (e.g., processor 103) that may determine signals to be transmitted to touch sensor 230 and/or that may determine how signals received from touch sensor 230 are processed.

As described above, a change in capacitance at a capacitive node of touch sensor 230 may indicate a touch or proximity input at the position of the capacitive node. A controller may detect and process the change in capacitance to determine the presence and location of the touch or proximity input. The controller may then communicate information about the touch or proximity input to one or more other components (e.g., processor 103), which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

In some embodiments, tracks of conductive material disposed on the substrate of touch sensor 230 may couple the drive or sense electrodes of touch sensor 230 to connection pads 254 and 260, also disposed on the substrate of touch sensor 230. Tracks may extend into or around (e.g., at the edges of) the touch-sensitive area(s) of touch sensor 230. Particular tracks may provide drive connections for coupling circuit 270 to drive electrodes of touch sensor 230, through which circuit 270 may supply drive signals to the drive electrodes. Other tracks may provide sense connections for coupling circuit 270 to sense electrodes of touch sensor 230, through which charge at the capacitive nodes of touch sensor 230 may be sensed. Tracks may be made of fine lines of metal or other conductive material.

In some embodiments, connection pads 254 and 260 may be implemented using conductive material, such as copper and may be located along one or more edges of the substrate, outside the touch-sensitive area(s) of touch sensor 230. Connection pads 254 and 260 may be implemented as tracks.

Although the description above contemplates sensing touch by capacitive sensing, it is understood that other forms of sensing may be used. For example, in some embodiments, touch sensor 230 may be configured to detect heat, and thus may sense touch based on variance in temperature of one portion of touch sensor 230 as compared to another.

In some embodiments, touch sensor 230 may be configured to resolve a fingerprint of a finger making contact with system 200. For instance, in embodiments in which touch sensor 230 is a capacitive sensor, measured capacitance on touch sensor 230 proximate to a finger touch may vary between the ridges and valleys of the fingerprint. As another example, in embodiments in which touch sensor 230 is a heat sensor, measured temperatures may vary between the ridges and valleys of the fingerprint. In such embodiments, the same touch sensor 230 may be employed to receive both natural interaction and biometric fingerprint data.

In other embodiments, two separate touch sensors 230 may be employed, wherein a first touch sensor 230 may be used to capture natural interaction while a second touch sensor 230 may be used to capture biometric fingerprint data of a user during the natural interaction. In such embodiments, a second sensor 230 may be overlaid upon cover 210, placed under cover 210, or proximate to the first sensor 230. In such embodiments, the two touch sensors 230 may be of different sensor types or have different sensor resolutions. For example, the second touch sensor 230 may have a greater resolution than the first touch sensor 230, allowing it to capture fingerprint detail while first touch sensor 230 is unable to do so. As another example, first touch sensor 230 may be a capacitive touch sensor while second touch sensor 230 may be a heat touch sensor. As yet another example, first touch sensor 230 may be a capacitive touch sensor while second touch sensor 230 may be an optical fingerprint or biometric reader.

In operation, user interface 110 employing a system 200 with touch sensor 230 may, in concert with biometric authentication module 106, continuously authenticate a user of information handling system 102 by capturing biometric fingerprint data during the user's natural interaction with user interface 110, thus also continuously detecting the presence of the user. Once a user has been authenticated and granted access to information handling system 102 (e.g., information handling system 102 has “unlocked”), biometric authentication module 106 monitors for biometric information received at user interface 110, and may withdraw access (e.g., “lock” information handling system 102) in the event that a fingerprint of the authenticated user is not captured within a specific user- or manufacturer-defined timeout duration (e.g., indicating that a user is not naturally interacting with information handling system 102 and is not present at the device) or may withdraw access in the event that user interface 110 captures biometric fingerprint information of a person who is not an authenticated user of information handling system 102 (e.g., indicating that a non-permitted user is attempting to access information handling system 102). In some embodiments, biometric authentication module 106 may withdraw access upon the number of consecutive reads of biometric fingerprint information not belonging to an authorized user exceeding a specific user- or manufacturer-defined threshold (e.g., two or more).

FIG. 3 illustrates a state diagram chart depicting an example method 300 for continuous biometric authentication and presence detection of a user of an information handling system, in accordance with certain embodiments of the present disclosure. Method 300 may be executed by biometric authentication module 106 and/or any other component of information handling system 102. As shown in FIG. 3, method 300 may have two states, a lock state 302 and an unlock state 304. In lock state 302, biometric authentication module 106 prevents a person from interacting with information handling system 102 and limits access to the applications and/or data present on information handling system 102, other than permitting a person to enter authentication information (e.g., a fingerprint) via user interface 110 (e.g., via the user-interactive area of user interface 110). Conversely, in unlock state 304, biometric authentication module 106 may allow a person to interface with information handling system 102 and allow access to the applications and/or data present on information handling system 102.

From lock state 302, biometric authentication module 106 may transition to unlock state 304 upon input of biometric fingerprint information via user interface 110 (e.g., via the user-interactive area of user interface 110) by touching a finger to user interface 110.

While in unlock state 304, biometric authentication module 106 may continuously monitor for biometric fingerprint information captured by user interface 110 during a user's natural interaction with the user-interactive area of user interface 110 including, in some embodiments, substantially the entire user-interactive area of user interface 110. If, during a specific user- or manufacturer-defined timeout duration, biometric fingerprint information for the authorized user is received and verified by biometric authentication module 106, biometric authentication module 106 may remain in unlock state 304 and the timeout duration may reset. However, if no biometric fingerprint information for the authorized user is received and verified by biometric authentication module 106 during the timeout duration, biometric authentication module 106 may transition to the lock state 302 and prevent access to information handling system 102. In addition, upon receiving biometric information via user interface 110 from a person that is not the authorized user, biometric authentication module 106 may transition to lock state 302 and prevent access to information handling system 102. In some embodiments, such transition to lock state 302 may occur only if the number of consecutive reads of biometric fingerprint information exceeds a specific user- or manufacturer-defined threshold (e.g., two or more).

Although FIG. 3 discloses a particular number of steps to be taken with respect to method 300, method 300 may be executed with greater or lesser steps or states than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a user interface comprising a touch sensor configured to detect biometric fingerprint data of a human interacting within a user-interactive area of the user interface; and
a processor communicatively coupled to the user interface and configured to:
receive biometric fingerprint data from the user interface inputted via the user interface during the human's natural interaction with the user interface;
determine if the biometric fingerprint data is that of an authorized user of the information handling system; and
restrict access to the information handling system in response to determining that the biometric fingerprint data is not that of an authorized user of the information handling system.

2. The information handling system of claim 1, the processor further configured to:
in response to determining that the biometric fingerprint data is that of an authorized user of the information handling system, determine if subsequent biometric fingerprint data of the authorized user of the information handling system is inputted within a timeout duration; and
restrict access to the information handling system in response to determining that subsequent biometric fingerprint data of the authorized user of the information handling system was not inputted within the timeout duration.

3. The information handling system of claim 1, wherein receiving biometric fingerprint data from the user interface inputted via the user interface during the human's natural interaction with the user interface comprises receiving biometric fingerprint data from substantially the entire user-interactive area of the user interface.

4. The information handling system of claim 1, wherein the touch sensor is a capacitive touch sensor.

5. The information handling system of claim 1, wherein the touch sensor is a heat sensor.

6. The information handling system of claim 1, wherein the touch sensor is an optical fingerprint reader.

7. The information handling system of claim 1, wherein the information handling system is of a form factor sized and shaped to be readily transported and carried on a person of a human.

8. A method comprising:
receiving biometric fingerprint data from a user interface comprising a touch sensor configured to detect biometric fingerprint data of a human interacting within a user-interactive area of the user interface, the biometric fingerprint data inputted via the user interface during the human's natural interaction with the user interface;
determining if the biometric fingerprint data is that of an authorized user of an information handling system comprising the user interface; and
restricting access to the information handling system in response to determining that the biometric fingerprint data is not that of an authorized user of the information handling system.

9. The method of claim 8, further comprising:
in response to determining that the biometric fingerprint data is that of an authorized user of the information handling system, determining if subsequent biometric fingerprint data of the authorized user of the information handling system is inputted within a timeout duration; and
restricting access to the information handling system in response to determining that subsequent biometric fingerprint data of the authorized user of the information handling system was not inputted within the timeout duration.

10. The method of claim 8, wherein receiving biometric fingerprint data from the user interface inputted via the user interface during the human's natural interaction with the user interface comprises receiving biometric fingerprint data from substantially the entire user-interactive area of the user interface.

11. The method of claim 8, wherein the touch sensor is a capacitive touch sensor.

12. The method of claim 8, wherein the touch sensor is a heat sensor.

13. The method of claim 8, wherein the touch sensor is an optical fingerprint reader.

14. The method of claim 8, wherein the information handling system is of a form factor sized and shaped to be readily transported and carried on a person of a human.

15. An article of manufacture comprising:
a computer readable medium; and
computer-executable instructions carried on the computer readable medium, the instructions readable by a processor, the instructions, when read and executed, for causing the processor to:
receive biometric fingerprint data from a user interface comprising a touch sensor configured to detect biometric fingerprint data of a human interacting within a user-interactive area of the user interface, the biometric fingerprint data inputted via the user interface during the human's natural interaction with the user interface;
determine if the biometric fingerprint data is that of an authorized user of an information handling system comprising the user interface; and
restrict access to the information handling system in response to determining that the biometric fingerprint data is not that of an authorized user of the information handling system.

16. The article of claim 15, the instructions for further causing the processor to:
in response to determining that the biometric fingerprint data is that of an authorized user of the information handling system, determine if subsequent biometric fingerprint data of the authorized user of the information handling system is inputted within a timeout duration; and
restrict access to the information handling system in response to determining that subsequent biometric fingerprint data of the authorized user of the information handling system was not inputted within the timeout duration.

17. The article of claim 15, wherein receiving biometric fingerprint data from the user interface inputted via the user interface during the human's natural interaction with the user interface comprises receiving biometric fingerprint data from substantially the entire user-interactive area of the user interface.

18. The article of claim 15, wherein the touch sensor is one of a capacitive touch sensor and a heat sensor.

19. The article of claim 15, wherein the touch sensor is an optical fingerprint reader.

20. The article of claim 15, wherein the information handling system is of a form factor sized and shaped to be readily transported and carried on a person of a human.
